(19) United States
(12) Patent Application Publication
(10) Pub. No.: US 2021/0236244 A1
(43) Pub. Date: Aug. 5, 2021

(54) SCAN POSTS SYSTEM AND METHOD

(71) Applicants: VP INNOVATO HOLDINGS LTD., Larnaca (CY); ROBOCAM, Warsaw (PL)

(72) Inventors: Ioannis VERGOULLIS, Rhodes (GR); Georgios PAPADOPOULOS, Rhodes (GR); Michael MICHALIK, Warsaw (PL); Robert MICHALIK, Otwock (PL)

(21) Appl. No.: 17/271,145

(22) PCT Filed: Aug. 30, 2019
(86) PCT No.: PCT/IB2019/057325

§ 371 Date: Feb. 24, 2021

(30) Foreign Application Priority Data
Aug. 31, 2018 (GR) 20180100395

(51) Int. Cl. A61C 8/00; A61C 9/00

(52) U.S. Cl. CPC A61C 8/0001; A61C 9/004; A61C 8/0053

(57) ABSTRACT

The present disclosure provides a scan posts system with a plurality of scan posts. Each scan post includes a scan post core and a scan post body surrounding the pillar of the core and resting in the shoulder of the core, wherein at least part of the scan post body is intended to be in contact with healing tissue. The scan post body of each scan post belongs to a group of scan post bodies comprising at least a combination of two different shapes with three different sizes and at least one height. Each scan post body includes at least one scan mark, the scan mark being suitable for providing information about the shape, size and height of the scan post to a scanning device, this information being useful for designing a dental implant prosthesis. The present disclosure also provides a method of manufacturing a dental implant prosthesis using such a scan post system.

### TECHNICAL FIELD

This invention belongs to the field of tools used by dentists for operating in dental tissue, in order to manage the soft tissue around implants or similar operations.

### STATE OF THE ART

The placement of a dental implant involves many operations, some of them being related to the manufacturing and handling of healing abutments and impression posts.

In some implant operations, when a dental implant is installed, it is convenient to place an adjacent scan post to provide external information about the evolution in the position and orientation of the dental implant, which is usually very difficult to obtain by external scan methods.

Scan posts are known to help dentists to calculate the location and orientation of a dental implant which has been installed in a patient's mouth. These scan posts are installed adjacent to a dental implant, and their shape is scanned by a device so that the orientation and the relative position of this scan post with respect of the rest of the teeth or another known reference is acquired. This data provide reliable information about the position and orientation of the dental implant which is not easily accessible.

Some documents provide ways of installing and measuring this information.

For example, in document EP 2462893 A1, a scanning member is provided, comprising a head portion with a flat top surface and a body portion which is non-rotationally coupled to the dental implant. The body portion is physically attached to a bottom surface of the head portion to form a generally “T” shape. This scanning member comprises at least two scan marks and also provides an internal through hole for receiving a screw to threadably couple with a threaded bore within the dental implant. By scanning the scanning member, the position and orientation of the hidden dental implant may be calculated.

These scan posts are useful for this purpose, and provide the dental practitioners with useful information which is used in dental operations.

### DESCRIPTION OF THE INVENTION

The invention provides an alternative solution for this problem by means of a scan posts system according to claim 1, and a method according to claim 19. Preferred embodiments of the invention are defined in dependent claims.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

In a first inventive aspect, the invention provides a scan posts system for being used in designing a dental implant prosthesis, the scans post system comprising a plurality of scan posts, each scan post comprising
a scan post core comprising a prosthetic connection, a pillar defining a pillar axis and a protruding shoulder between the pillar and the prosthetic connection;
a scan post body surrounding the pillar and resting in the shoulder, the scan post body defining a body axis, wherein at least part of the scan post body is intended to be in contact with healing tissue;

wherein the scan post body of each scan post belongs to a group of scan post bodies comprising at least a combination of two different shapes with three different sizes and at least one height;

wherein each scan post body comprises at least one scan mark, the scan marks being suitable for providing information about the shape, size and height of the scan post to a scanning device, this information being useful for designing a dental implant prosthesis.

This invention provides a set with a plurality of scan posts. Each scan post comprises one scan post core and one scan post body. The scan post core of each scan post is substantially the same, but each scan post comprises a scan post body which is different from the scan post body of a different scan post of the system. These scan bodies are selected from a group of scan bodies which comprises a combination of different features. For example, if the group of scan bodies comprises three different sizes, two different shapes and two different heights, the scan body system comprises 12 different scan posts. The scan post core of each one the 12 scan posts are substantially identical, but each scan post comprises a scan body which is selected from this group of 12 scan post bodies. As a consequence, the most suitable scan body may be selected to be part of the dental implant prosthesis design process, depending on the shape of the patient's jaw and natural dentition.

It is understandable that the above system could also be available in a more or less simplified format comprising a smaller or a greater number of components. The shapes and dimensions of anterior teeth and premolars are very similar, so the dental practitioner could prefer using a combo shape so that a set of three components (same shape but 3 different sizes) would be able to closely mimic these shapes in a satisfactory manner. The same applies for the shapes of maxillary and mandibular molars. Thus a system comprising six scan bodies (three for anterior and premolars with sizes small, medium, large and three for molars, small medium, large) could cover the basic needs of most clinical cases in an acceptable fashion, while reducing the number of components and thus the cost of the system for the dentist.

It is also understandable that the components of the system could be available in the market also as separate pieces so that a dentist can purchase when needed only the scan post in need for his clinical case. If for example one of the scan posts of the system is lost or malfunctions, then the dentist will be able to replace this specific scan post in need.

This fact make this scan post set suitable for helping the implant process occur in a more healthy way, since the scan post are intended to improve the healing process, since the ability of selecting the most suitable scan post from a group of predetermined and pre-manufactured scan posts, which may be stored in a digital library, for example, helps the tissue to grow in a more natural way, avoiding problems in further stages of this process. This scan post is helpful for manufacturing a dental implant prosthesis with anatomic sub-gingival and cervical profile.

In some particular embodiments, the scan post body of each scan post belongs to a group of scan post bodies comprising at least a combination of three different shapes with three different sizes and more than one height; and wherein each scan post body comprises scan marks.

In other cases, the dental practitioner could choose using a more detailed set, to try to have a better fitting between the scan post and the required part.

In some particular embodiments, at least part of the scan post body and the shoulder of the scan post core form a continuous and derivable surface.

In each of the scan bodies, the surface formed by the shoulder and the scan post body is intended to be in contact with healing tissue when this tissue grows around the installed scan body. Hence, this scan post can further assist with proper shaping of the healing soft tissue according to the desired cervical and sub-gingival shape of the final prosthesis and accurately recording the latter through a digital intra-oral scanning process.

In some particular embodiments, the scan post body and the scan post core are part of the same piece. This could make manufacturing easier.

In some particular embodiments, the continuous and derivable surface formed by the scan post body and at least part of the scan post body comprises a convex portion and a concave portion, the concave portion being closer to the prosthetic connection than the convex portion.

This structure of convex and concave portions is natural for the healing tissue, thus contributing for a natural healing process.

In some particular embodiments, the body axis is offset in relation to the pillar axis. Thus, the scan post comprises an asymmetrical cross section. This is particularly useful for clinical cases where the implant has been placed in an off-set position in relation to the center of the available prosthetic space. In these cases, the offset scan post body will form favorably the soft tissue profile, compensating for the offset position of the implant and thus of the scan post core that is assembled to the implant.

In some particular embodiments, the scan post body and the scan post core have attaching means configured to be attached between themselves in more than one position, so that the pillar axis and the body axis may form different angles. Specifically, this scan post body comprises more than one engaging surfaces in its internal part capable of interacting with the engaging surface of the scan post core in different lateral positions. This way the same scan post core and body can assemble in different configurations so that scan posts with different configurations between body and core can be made with regards to the final lateral and/or vertical position of the body in relation to the core.

As a consequence, in some particular embodiments, the body axis is not parallel to the pillar axis, but instead they form an angle that might vary from 1 to 45 degrees.

In some particular embodiments, the at least one scan mark is configured to provide information about the shape, size and height of the scan post body and orientation and location information.

These scan marks provide a scan tool with valuable information about the shape, size, height, orientation and location of the scan post.

In some particular embodiments,
the shape of the scan body of each scan post is defined by a cross section in a plane perpendicular to the pillar axis which crosses the scan post at its maximum equivalent diameter,
the equivalent diameter is the maximum distance between two points belonging to said cross section, and
this cross section is, for each scan post, one of a triangle with rounded edges, a square with rounded edges, a parallelogram with rounded edges or an ovoid.

Scan bodies are therefore identified by the shape thereof in the portion with the maximum equivalent diameter, which is usually the top portion of the scan body, the portion which is farthest from the prosthetic connection. This way of identify the main shape of the scan body is an easy way of choosing a preliminary shape for each particular type of tooth.

The shapes of a triangle with rounded edges, square with rounded edges, parallelogram with rounded edges or ovoid are a way of defining these shapes. As may be seen throughout the document, the “ovoid” shape has four curved sides with four rounded corners, but any other suitable shape may be chosen in order to adjust to the edentulous space.

The scan post bodies have a cross section which may vary in size and/or shape while advancing upwards from the shoulder, but all cross sections are oriented according to parallel planes, which are perpendicular to the pillar axis. These types of cross sections adapt to the dental pieces in a very good way. Triangles with round edges, squares with round edges and rectangles with round edges are examples of shapes which may adapt to the cervical portion of the patient's edentulous space.

In some particular embodiments, the shape of the scan body is non-circular and the scan body contains only one scan mark.

These inventive scan posts comprise only one marker, usually on the top or one of the lateral surfaces of the scan post body, capable of providing the necessary information for identifying the three dimensional position of the said scan post in the jaw. The inventive scan post may operate with only one marker available, since the scan post body comprising a non-circular shape can provide reference points originating from this section that, in combination with the one scan mark, are enough to provide all the necessary information needed to the CAD-CAM station.

In some particular embodiments, the height of the scan body of each scan post is defined by the distance between the cross section of the scan post with minimum equivalent diameter and the cross section of the scan post with maximum equivalent diameter, wherein the equivalent diameter is the maximum distance between two points belonging to said cross section, and particularly wherein this height is classified in ten different heights, namely 2.5 mm, 3.0 mm, 3.5 mm, 4.0 mm, 4.5 mm, 5.0 mm, 5.5 mm, 6.0 mm, 6.5 mm and 7.0 mm. It should be understood that these heights are just a particular example based on currently available data and can be further adjusted or enriched if clinical needs in the future demand to do so.

The relevant height of a scan post is not always the total height thereof. The distance between the plane with maximum equivalent diameter and the plane with minimum equivalent diameter is a good indicator, since the maximum equivalent diameter defines the width of the scan post and the future dental implant prosthesis.

Depending on the features of patient's teeth, it will be suitable to choose a scan post belonging to one of these height categories.

In some particular embodiments, the size of the scan body of each scan post is defined by the equivalent diameter of the cross section of the in a plane perpendicular to the pillar axis which crosses the scan post at its maximum equivalent diameter, wherein the equivalent diameter is the maximum distance between two points belonging to said cross section, this size being classified into at least three categories, the small one being comprised between 4.5 and 6 mm, the medium one being comprised between 6.5 and 8 mm and the big one being comprised between 8 and 12 mm.

The size of the scan post body is another key feature, which is chosen depending on the type of the tooth and on the patient itself. In particular cases, this size category depends on the shape of the scan post. For example, a triangular shape will be available in three sizes, a small size of 4.5 mm, a medium size of 6 mm and a large size of 7 mm. But another shape, such as a parallelogram size, may be available in a small size of 6 mm, a medium size of 7 mm and a large size of 8 mm.

In some particular embodiments, at least some scan post bodies have different shapes at different cross sections perpendicular to the pillar axis, and wherein the scan marks comprise information about these different shapes and the distance of the perpendicular planes from the top of the scan post body.

The anatomical shape of a scan post may be therefore chosen, not only by the main shape, which is defined by the shape in the cross section with maximum equivalent diameter, but also by intermediate shapes, which may be different from this main shape. This information is encoded by the scan marks so that the dental practitioner may have complete information of the scan post which has been placed in the patient's mouth.

In some particular embodiments,
at least some scan post bodies have a circular cross section in a plane perpendicular to the pillar axis which crosses the scan post body at its minimum equivalent diameter, wherein the equivalent diameter is the maximum distance between two points belonging to said cross section; and
the scan mark is configured to provide information about the size and height of the circular cross section.

The root trunk is a portion of the tooth root which has a vertical dimension of several millimeters. The crown of the tooth has a portion called cervical margin, which is located at the level of the free gingival margin. The cervical portion usually has a vertical dimension between 0.5 and 2 mm. The scan posts of the invention are adapted to fit these two portions.

A circular cross section in this location with minimum equivalent diameter, which is usually the portion which is closest to the shoulder, is advantageous, since the anatomical profile is mostly needed at the area of the gingival margin that will receive the cervical margin of the implant prosthesis. Below this area there is a transition zone which coincides with this zone with minimum equivalent diameter, wherein maximum tissue thickness is desired and a circular cylindrical shape is advantageous to provide the least diameter circumferentially in comparison to other shapes.

Scan marks help the practitioner when identifying scan posts which have this “combo shape”, since the healing tissue may have grown to such a height that visual identification provides no help to determine the best shape for the dental implant prosthesis.

In some particular embodiments, each scan post further comprises a securing screw which is configured to securely attach the scan post core to an implant. This securing screw is a reliable solution for this purpose. This feature is particularly important when the scan post is intended to be left in the mouth for prolonged period of times in order for the healing tissue to favorably adapt and shape as it will ensure no micro-motion or dislodgement of the scan body from the scan post core during masticatory function.

In some particular embodiments, the scan post body of at least one of the scan posts has a first engager and the scan post core of the same scan post has a second engager, in such a way that the first engager and the second engager admit at least two positions where the scan post body and the scan post core are engaged with no rotation allowed.

These two positions allow the scan post body to be attached to the scan post core in two different positions, such as, for example, facing mesially-distally or buccally-lingually. With a single element, both options are available, thus increasing the ability to adapt to the patient's edentulous space.

The above two positions might also be configured so that allow the scan post body to be attached to the scan post core in two different lateral positions, such as, for example centered or off-centered in relation to each other.

In more particular embodiments, the first engager comprises one protrusion and the second engager comprises two recesses where the protrusion may be received, so that when the protrusion is received by one of the recesses, the scan post body and the scan post core are engaged in a first position and when the protrusion is received in the other recess, the scan post body and the scan post core are engaged in a second position.

These engagers might provide by themselves enough stability with regards to connection of the two parts. However the connection of the two parts, scan post body and scan post core, can be furthered enhanced/secured by gluing the two parts together with suitable bonding agent.

In some particular embodiments, the scan post bodies comprise a regular surface, as that which may be expressed by a polynomic, exponential or logarithmic mathematical formula, or a combination thereof, with a mean roughness Ra lower than 10 μm.

These scan posts have a regular and smooth surface, which is more favorable for the patient's gingival healing tissue profile and allow better hard and soft tissue adaptation.

In a second inventive aspect, the invention provides a method of manufacturing dental implants prostheses, the method comprising the steps of
attaching a scan post belonging to the scan posts system according to any of the preceding claims to a dental implant present in an edentulous space;
letting healing tissue grow around the scan post body;
scanning the scan post scan marks to obtain the position and orientation of the scan post and a map of the healing tissue around the scan post body; and
manufacturing a dental implant prosthesis with the information obtained in the previous step, wherein at least part of the implant prosthesis is a replicate of the scan post body.

Processes known by the skilled person include using a temporary prosthesis placed on the implant and allow the tissue grow around it. However, when the scan post used in these methods is cylindrical, and this does not fit the sub-gingival tissue which has grown around the temporary prosthesis. As a consequence, the scanning process cannot obtain data of the gap between the sub-gingival tissue profile and the shape of the scan post. With the method of the invention, this problem is solved, since the same element is used for the tissue to grow around it and for the scanning process, ensuring that the sub-gingival tissue has the suitable profile which matches the profile of the scan post. As a consequence, the dentist can manufacture a final prosthesis which will match perfectly to both the sub-gingival profile and the healing tissue, and this by using a single scanning process.

When the scan post is scanned, the scanner identifies, due to the scan marks, the shape of the scan post. Further, the scanner also acquires a map of the healing tissue. The combination of the map of the healing tissue profile and the shape, size and orientation of the scan post provides the practitioner with information to manufacture a suitable dental implant prosthesis. The shape and size of the scan post is included in a digital library, and the scan marks allows the identification of the particular model of the digital library, so that the use of some processing means may lead to achieve the complete shape of the most suitable dental implant prosthesis.

In some particular embodiments, between the steps of scanning the scan post marks and manufacturing a dental implant prosthesis, the method further comprises the steps of
providing the scan data to a cad station comprising the available digital library that comprises the design information of the said scan post; and
designing an implant prosthesis where at least part of the prosthesis that is located at and/or below the free margin of the gingival tissue is a replicate of the corresponding portion of said scan post in shape and dimensions.

Current practice, after soft tissue has been anatomically modeled by a temporary prosthesis, requires one additional, separate scanning of the soft tissue architecture. This is because the sub-gingival portion of the current scan posts do not carry an anatomical design, but instead they comprise a cylindrical design that does not match the one of the modeled gingival tissue. The inventive scan post models the tissue directly and eliminates need of using a temporary prosthesis for this purpose. Since the sub-gingival portion of the inventive scan post perfectly matches the shape of the sub-gingival tissue there is no need for a separate scanning in order to get the mapping of the latter. This feature reduces the working time and complexity of the procedure.

In some particular embodiments, the scan post is chosen from the scan post system after measuring the distance between the dental implant platform and a cervical margin location and/or the cervical margin of the future prosthesis, either directly on the patient's mouth or extra-orally in a stone working model, or a digital working model or a CT scan, or a CBCT scan, or a combination thereof. In these cases, based on the selection of the proper inventive scan post a digital model can be fabricated, representing the jaw of the patient, the location of the implants and the selected scan posts installed onto the latter. This digital model can be exported as an STL file and sent to a lab so that the latter can pre-fabricate a final prosthesis where the cervical and/or the sub-gingival design of the prosthesis is the replicate of the selected inventive scan post.

This distance, between the dental implant platform and a cervical margin location, is important, since it will define the height of the scan post to be chosen. As had been defined before, this height is the distance between the plane with the minimum equivalent diameter and the plane with the maximum equivalent diameter. The cervical margin shape and size of the future prosthesis is also important as it will define the shape and size of the scan post body to be chosen.

As had been defined before,
the shape of the scan body of each scan post is defined by a cross section in a plane perpendicular to the pillar axis which crosses the scan post at its maximum equivalent diameter,
the equivalent diameter is the maximum distance between two points belonging to said cross section, and
this cross section is, for each scan post, one of a triangle with rounded edges, a square with rounded edges, a parallelogram with rounded edges or an ovoid.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows a generic view of a scan posts system according to the invention.

FIG. 2 shows a vertical section view of a particular embodiment of a scan post belonging to a scan posts system according to the invention.

FIGS. 3a and 3b show different cross sections of a scan body of a scan post of a scan post system according to the invention.

FIG. 4 shows a detail of a scan post of a scan post system according to the invention.

FIG. 5 shows a step of a method according to the invention.

FIG. 6 shows another step of a method according to the invention.

FIG. 7 shows a scan post which belongs to a scan post system according to the invention.

FIGS. 8a and 8b show two examples of scan posts belonging to a scan post system according to the invention.

FIGS. 9a to 9d show different engagement actions between a scan post core and a scan post body in scan posts belonging to a scan post system according to the invention.

### DETAILED DESCRIPTION OF THE INVENTION

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

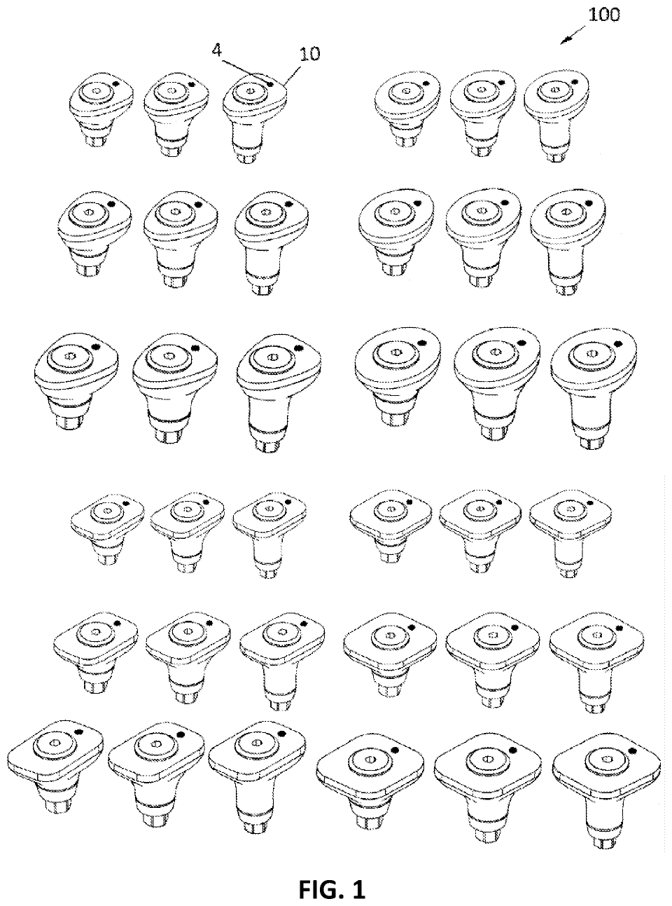

FIG. 1 shows a generic view of a scan posts system 100 according to the invention. This scan post system is suitable for being used in designing a dental implant prosthesis.

As will be shown below, each scan post belonging to the scan posts system comprises a scan post core and a scan post body. The scan post body is different for each scan post, while the scan post core is substantially the same for each scan post.

This system 100 comprises 36 scan posts 10, which responds to the combination between four different shapes (rectangular with round edges, triangular with round edges, ovoid and square with round edges), three different sizes (small, medium and large) and three different heights (short, medium and long).

Every scan post 10 comprises several scan marks 4, one of them containing information about the shape, the size and the height of the scan post 10, which may be easily read and interpreted by a scanning tool. Further, other scan marks will be also useful for the scanning tool to provide position and orientation information of the scan post 10.

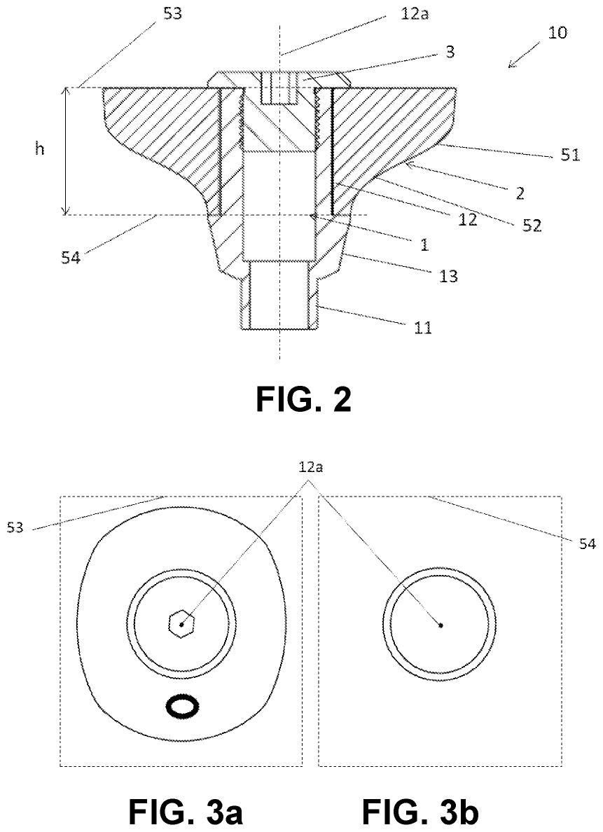

FIG. 2 shows a vertical section view of a particular embodiment of a scan post 10 belonging to a scan posts system according to the invention.

This scan post 10 comprises a scan post core 1 and a scan post body 2. The scan post core 1 comprises a prosthetic connection 11, a pillar 12 defining a pillar axis 12a and a protruding shoulder 13 between the pillar 12 and the prosthetic connection 11. The scan post body 2 in turn surrounds the pillar 12 and rests in the shoulder 13. This scan post body 2, or at least part of it, is intended to be in contact with healing tissue. The scan post 10 further comprises a retention screw 3 which is configured to provide a secure attachment between the scan post body 2 and the scan post core 1.

The lateral surface of the scan post body and the shoulder form a continuous and derivable surface. This surface comprises a convex portion 51 and a concave portion 52, the concave portion 52 is closer to the prosthetic connection 11 than the convex portion 51.

The height h of the scan body of this scan post is defined as the distance between the plane with minimum diameter and the plane with maximum diameter. In this figure, these planes are seen as lines 53, 54, since they are perpendicular to the pillar axis 12a.

FIGS. 3a and 3b show different cross sections of this scan body 10, the two of them being according to these aforementioned planes of maximum and minimum equivalent diameter. The cross section shown in FIG. 3a is made according to the plane 53 where the equivalent diameter is the maximum one, and in this case corresponds to the top portion of the scan post body. The cross section shown in FIG. 3b is made according to the plane 54 where the equivalent diameter is the minimum one, and in this case corresponds to the bottom portion of the scan post body.

The equivalent diameter is considered as the maximum distance between two points belonging to said cross section.

FIG. 3a shows the cross section of a particular example of a scan post where the shape in this maximum equivalent diameter section is an ovoid with rounded edges.

FIG. 3b shows in turn the cross section of the same scan post wherein the shape in this minimum equivalent diameter section is a circle.

The size of the scan body of each scan post is defined by the equivalent diameter of the cross section of the in a plane perpendicular to the pillar axis which crosses the scan post at its maximum equivalent diameter. As a consequence, in this case, this scan post would be considered as an ovoid scan post. However, the rounded cylindrical shape in the bottom portion is advantageous, since maximum tissue thickness is desired in this zone and a circular cylindrical shape is advantageous to provide the least diameter circumferentially in comparison to other shapes.

This scan post starts with a cylindrical shape and then expands laterally upwards in a concave manner till it reaches its maximum diameter and at which point comprises a generally ovoid shape with rounded edges. The vertical location of the maximum diameter and thus the location of the anatomical shape may be different in the different groups and within the same group of shapes. The inventive custom scan posts comprise marks that additionally provide this information.

This size may be classified into at least three categories, the small one being comprised between 4 and 6 mm, the medium one being comprised between 6.5 and 8.5 mm and the big one being comprised between 9 and 12 mm.

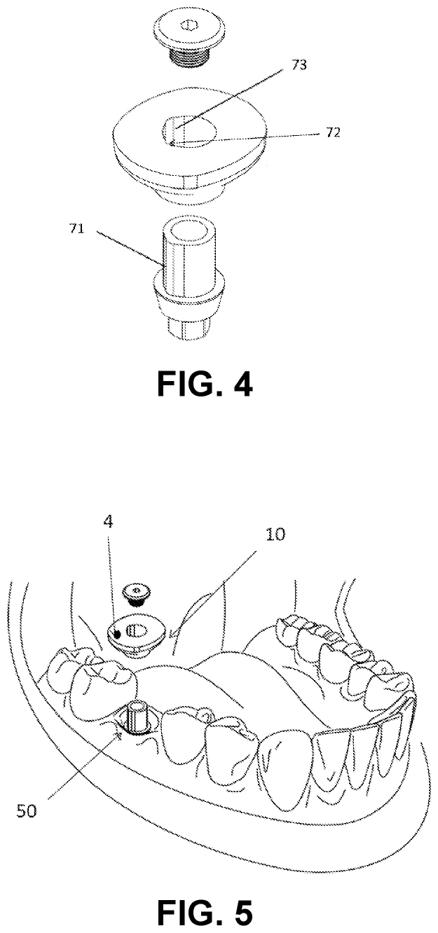

As may be shown in FIG. 4, the scan post body has a first engager and the scan post core has a second engager. The first engager comprises one protrusion 71 and the second engager comprises two recesses 72, 73 where the protrusion may be received, so that when the protrusion 71 is received by one of the recesses 72, the scan post body and the scan post core are engaged in a first position and when the protrusion 71 is received in the other recess 73, the scan post body and the scan post core are engaged in a second position.

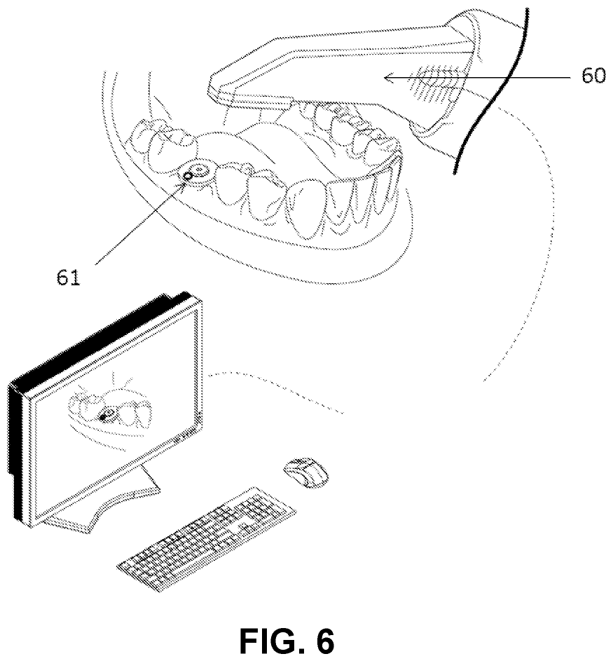

This scan posts system may be used in a method for manufacturing dental implants prostheses as shown in FIGS. 5 and 6, the method comprising the steps of
attaching a scan post 10 belonging to the scan posts system according to any of the preceding claims to a dental implant present in an edentulous space,
letting healing tissue grow around the scan post body;
scanning the scan post scan marks to obtain the position and orientation of the scan post and a map of the healing tissue around the scan post body; and
manufacture a dental implant prosthesis with the information obtained in the previous step.

The scan post is chosen from the scan post system after identifying the type and size of tooth missing and thus the best corresponding shape and size of scan body and measuring the distance between the dental implant and a cervical margin location, either directly on the patient's mouth or extra-orally.

Then, as shown in FIG. 5, the chosen scan post 10 is attached to a dental implant 50 which is already present in the edentulous space of a patient. This scan post 10 comprises scan marks 4, so that it may be scanned in a subsequent step.

Once the healing tissue has been grown around the scan post, the scan post may be scanned with a scanner device 60 to obtain the position and orientation of the scan post, but also the gingival tissue profile 61 around the scan post. This map of the healing tissue is important to manufacture the final dental implant prosthesis which will be installed instead of the scan post.

FIG. 6 shows a CAD station where these data are received, and the final prosthesis is designed, taking into account the data obtained from the scan post and the healing tissue map also obtained by the scanner.

With these data, a suitable dental implant prosthesis will be manufactured. This prosthesis will adapt in an advantageous way to the edentulous space and to the gingival profile which has been sculpted by the scan post of the invention, and at least part of the prosthesis comprising its cervical profile and/or part of its subgingival portion will be a replicate of the inventive scan post.

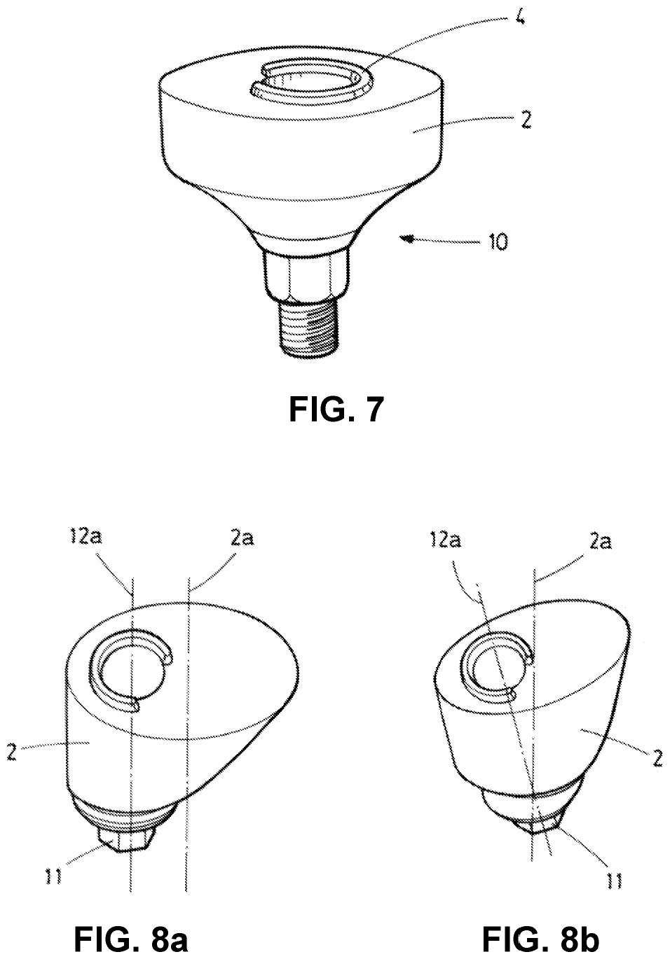

FIG. 7 shows a scan post 10 which belongs to a scan post system according to the invention. This scan post has a scan post body 2 with a shape which is non circular and contains only one scan mark 4.

This scan post 10 comprise only one mark 4. In this case, it is located on top of the scan post body 2, but any other location would be suitable as well. This mark is capable of providing the necessary information for identifying the three dimensional position of the said scan post in the jaw, since the scan post body comprising a non-circular shape provides reference points due to its shape that, in combination with the scan mark, are enough to provide all the necessary information needed to the CAD-CAM station.

FIGS. 8a and 8b show two examples of scan posts 10 belonging to a scan post system according to the invention, which have a special alignment of the pillar axis and/or body axis.

FIG. 8a shows a scan post wherein the body axis 2a is off-set in relation to the pillar axis 12a. The pillar axis 12a is defined by the orientation of the prosthetic connection 11 and the pillar. In this case, the body axis 2a is parallel to the pillar axis 12a, but is offset with respect to it. As a consequence, the scan post body 2 is offset with respect to the position of the prosthetic connection 11, which is the piece that will be inserted in the patient's edentulous space. This type of scan posts are useful in particular geometries where the standard ones do not fit.

FIG. 8b shows a different scan post, where the body axis 2a and the pillar axis 12a form an angle, which may be comprised between 1 and 45 degrees. The prosthetic connection 11 is angled with respect to the body axis 2a. This type of scan posts are also useful in particular geometries where the standard ones do not fit.

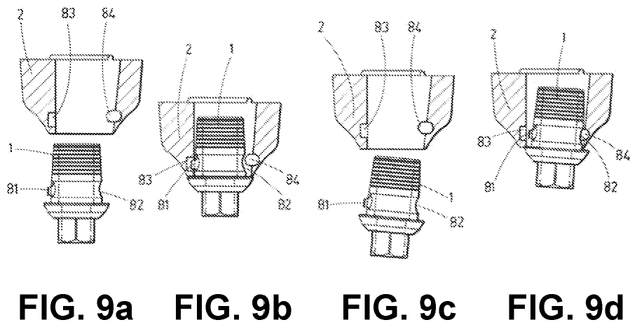

FIGS. 9a to 9d show different engagement actions between a scan post core 1 and a scan post body 2 in scan posts 10 belonging to a scan post system according to the invention.

In all these figures, the scan post core 1 comprises a connection protrusion 81 and a connection recess 82, while the scan body 2 comprises a connection housing 83 and a connection ball 84. These elements are configured to allow the scan post body to be attached to the scan post core in two different lateral positions.

FIGS. 9a and 9b shows the coupling between a scan post core 1 and a scan post body 2. When the scan post core 1 is inserted vertically, the scan post core 1 fits in a first position with respect to the scan post body 2, and the connection protrusion 81 is coupled to the connection housing 83.

In FIGS. 9c and 9d, this coupling is different. The scan post core is inserted diagonally, so, in this case, the connection ball 84 is coupled to the connection recess 82, to achieve an angulated result.

1.-20. (canceled)

21. A scan post system for being used in designing a dental implant prosthesis, the scan post system comprising a plurality of scan posts, each scan post comprising:
a scan post core comprising a prosthetic connection, a pillar defining a pillar axis and a protruding shoulder between the pillar and the prosthetic connection; and
a scan post body surrounding the pillar and resting in the shoulder, the scan post body defining a body axis, wherein at least part of the scan post body is intended to be in contact with healing tissue;
wherein the scan post body of each scan post is different and belongs to a group of scan post bodies comprising at least a combination of two different shapes with three different sizes and at least one height, thus resulting at least six different scan post bodies,
wherein each scan post body comprises at least one scan mark, the scan marks being suitable for providing information about the shape, size and height of the scan post to a scanning device, this information being useful for designing a dental implant prosthesis,
wherein the scan post body of at least one of the scan posts has two recesses and the scan post core of the same scan post has one protrusion, so that when the protrusion is received by one of the recesses, the scan post body and the scan post core are engaged in a first position with no rotation allowed and when the protrusion is received in the other recess, the scan post body and the scan post core are engaged in a second position with no rotation allowed,
wherein the shape of the scan body of each scan post is defined by a cross section in a plane perpendicular to the pillar axis which crosses the scan post at its maximum equivalent diameter,
wherein the equivalent diameter is the maximum distance between two points belonging to said cross section, and
wherein this cross section is, for each scan post, one of a triangle with rounded edges, a square with rounded edges, a parallelogram with rounded edges or an ovoid.

22. The scan post system according to claim 21, wherein the scan post body of each scan post belongs to a group of scan post bodies comprising at least a combination of three different shapes with three different sizes and more than one height; and wherein each scan post body comprises scan marks.

23. The scan post system according to claim 21, wherein at least part of the scan post body and the shoulder of the scan post core form a continuous and derivable surface.

24. The scan post system according to claim 23, wherein the scan post body and the scan post core are part of the same piece.

25. The scan post system according to claim 23, wherein the continuous and derivable surface formed by the shoulder and at least part of the scan post body comprises a convex portion and a concave portion, the concave portion being closer to the prosthetic connection than the convex portion.

26. The scan post system according to claim 21, wherein the body axis is off-set in relation to the pillar axis.

27. The scan post system according to claim 21, wherein the scan post body and the scan post core have attaching means configured to be attached between themselves in more than one position, so that the pillar axis and the body axis form different angles.

28. The scan post system according to claim 21, wherein the at least one scan mark is configured to provide information about at least one of the shape, size and height of the scan post body and orientation and location information.

29. The scan post system according to claim 21, wherein the shape of the scan body is non-circular and the scan body contains only one scan mark.

30. The scan post system according to claim 21, wherein the height of the scan body of each scan post is defined by the distance between a plane comprising the cross section of the scan post with minimum equivalent diameter and a plane comprising the cross section of the scan post with maximum equivalent diameter, wherein the equivalent diameter is the maximum distance between two points belonging to said cross section.

31. The scan post system according to claim 21, wherein the size of the scan body of each scan post is defined by the equivalent diameter of the cross section of the in a plane perpendicular to the pillar axis which crosses the scan post at its maximum equivalent diameter, wherein the equivalent diameter is the maximum distance between two points belonging to said cross section, this size being classified into at least three categories, a first category involving a size comprised between 4.5 and 6 mm, a second category involving a size comprised between 6.5 and 8 mm and a third category involving a size comprised between 8 and 12 mm.

32. The scan post system according to claim 21, wherein at least two scan post bodies have different shapes at different cross sections perpendicular to the pillar axis, and wherein the scan marks comprise information about these different shapes and the distance of the perpendicular planes from the top of the scan post body.

33. The scan post system according to claim 21,
wherein at least two scan post bodies have a circular cross section in a plane perpendicular to the pillar axis which crosses the scan post body at its minimum equivalent diameter, wherein the equivalent diameter is the maximum distance between two points belonging to said cross section; and
wherein the scan mark is configured to provide information about the size and height of the circular cross section.

34. The scan post system according to claim 21, wherein each scan post further comprises a securing screw which is configured to securely attach the scan post core to an implant.

35. The scan post system according to claim 21, wherein the scan post bodies comprise a regular surface.

36. The scan post system according to claim 35, wherein the regular surface is expressed by a polynomic, exponential or logarithmic mathematical formula, or a combination thereof, with a mean roughness Ra lower than 10 μm.

37. A method of manufacturing dental implants prostheses, the method comprising:
attaching a scan post selected from the scan post system of claim 21 to a dental implant present in an edentulous space;
waiting for healing tissue to grow around a scan post body of the scan post;
scanning a scan post scan mark on the scan post body to obtain scan data comprising a position of the scan post, an orientation of the scan post and a map of the healing tissue around the scan post body; and
manufacturing a dental implant prosthesis using the scan data,
wherein at least part of the dental implant prosthesis is a replicate of the scan post body.

38. The method according to claim 37 wherein, after scanning the scan post mark and before manufacturing a dental implant prosthesis, the method further comprises:
providing the scan data to a cad station comprising an available digital library that comprises design information of the scan post; and
designing the dental implant prosthesis so that at least part of the dental implant prosthesis to be located at and/or below a free margin of the healing tissue is a replicate of a corresponding portion of the scan post in shape and dimensions.

39. The method according to claim 37, wherein the scan post is selected from the scan post system after measuring a distance between the dental implant and a cervical margin location in the edentulous space.
